(19) United States
(12) Patent Application Publication
(10) Pub. No.: US 2002/0048296 A1
(43) Pub. Date: Apr. 25, 2002

(54) Laser module having cooling function, and method of manufacturing the same

(76) Inventors: Kazuya Kuriyama, Hirakata (JP); Kanichi Kadotani, Atsugi (JP)

Correspondence Address: STEVENS, DAVIS, MILLER & MOSHER, L.L.P., Suite 850, 1615 L Street, N.W., Washington, DC, 20036, US

(21) Appl. No.: 09/978,198

(22) Filed: Oct. 17, 2001

(30) Foreign Application Priority Data
Oct. 19, 2000 (JP) 2000-319259

(51) Int. Cl. H01S 3/04

(52) U.S. Cl. 372/36; 372/34

(57) ABSTRACT

A laser module capable of improving the heat exchange properties between a thermoelectric module and a semiconductor laser than previously possible. The laser module has a thermoelectric module including a plurality of thermoelectric elements and first and second substrates for sandwiching the plurality of thermoelectric elements therebetween, at least the first substrate being made of silicon; and a semiconductor laser formed on the first substrate of the thermoelectric module.

### BACKGROUND OF THE INVENTION

1. Field of the Invention

The present invention relates to a laser module which includes a thermoelectric module adapted to cool a semiconductor laser, to have a cooling function. Further, the present invention relates to a method of manufacturing such a laser module.

2. Description of a Related Art

Research and development is recently progressing for applying a thermoelectric module utilizing thermoelectric effect (e.g., Seebeck effect, Peltier effect, and Thomson effect) to the temperature control of the semiconductor laser. FIG. 8 shows an exemplary configuration of a laser module provided with such a thermoelectric module.

As shown in FIG. 8, the laser module designated generally by 100 comprises a thermoelectric module 101 mounted within the interior of a housing 113. To provide connections with external circuits, a plurality of lead wires 114 extend parallel to the top surface of the housing 113. The thermoelectric module 101 comprises a plurality of thermoelectric elements 102 and two substrates 103 and 104 which sandwich the thermoelectric elements 102 therebetween. The substrates 103 and 104 are both made of alumina.

A semiconductor laser 105 is formed on the top surface of the substrate 103. The semiconductor laser 105 includes a silicon substrate 106 having a top surface to which are attached a laser chip 108, a photodiode 109, a thermistor 110, etc. The substrate 106 is soldered to the top surface of the substrate 103 of the thermoelectric module 101, with a solder layer 107 intervening between the substrates 103 and 106.

In the semiconductor laser 105, the photodiode 109 receives laser beams emitted leftward in the diagram from the laser chip 108 and issues electric signals which depend on the intensity of the beams. The thermistor 110 is used for, e.g., detection of an extraordinary rise in temperature of the substrate 106. Laser beams output rightward in the diagram from the laser chip 108 pass through the optical isolator 111 and the lens 112 in the mentioned order and transmit through the interior of an optical fiber 115 which extends to the exterior of the housing 113.

In the conventional laser module 100 as shown in FIG. 8, however, heat generated by the semiconductor laser 105 is transmitted through the three layers, i.e., the substrate 106, the solder layer 107 and the substrate 103 in the mentioned order. A poor thermal conductive efficiency was therefore present between the thermoelectric module 101 and the semiconductor laser 105, which was desired to be improved.

By the way, Japanese Patent Laid-open Publication JP-8-46248 discloses a thermoelectric module having two silicon substrates for sandwiching a plurality of thermoelectric elements therebetween. However, the thermoelectric module disclosed in the above publication is not intended for use of cooling the semiconductor laser included in the laser module.

### SUMMARY OF THE INVENTION

In view of the above circumstances, the object of the present invention is to provide a laser module capable of achieving an improved heat exchange efficiency between a thermoelectric module and a semiconductor laser, and to provide a method of manufacturing the laser module.

In order to solve the above problems, according to a first aspect of the present invention, there is provided a laser module comprising: a thermoelectric module including a plurality of thermoelectric elements, and a first substrate and a second substrate for sandwiching the plurality of thermoelectric elements therebetween, at least the first substrate being made of silicon; and a semiconductor laser formed on the first substrate of the thermoelectric module.

In order to solve the above problems, according to a second aspect of the present invention, there is provided a method of manufacturing a laser module comprising the steps of: (a) assembling a thermoelectric module by sandwiching a plurality of thermoelectric elements between a first substrate and a second substrate, at least the first substrate being made of silicon; and (b) forming a semiconductor laser on the first substrate of the thermoelectric module.

In the laser module of the present invention, heat generated by the semiconductor laser is conveyed to the thermoelectric element by way of the first substrate made of silicon so that the semiconductor laser is cooled. Silicon has a higher thermal conductivity than alumina, and hence it is possible to keep a uniform temperature within the surface of the first substrate and enhance the heat exchange efficiency between the thermoelectric module and the semiconductor laser as compared with the prior art, to thereby achieve a rapid effective cooling of the semiconductor laser.

Since silicon is superior in micro-processibility including etching, markings indicative of the positions of elements (e.g., a laser chip and a thermistor) constituting the semiconductor laser or fixing grooves for fixing the elements can be formed in the surface of the first substrate by, e.g., etching, whereby the positioning accuracy upon mounting of the elements on the first substrate can be improved.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram showing the configuration of a laser module according to one embodiment of the present invention;

FIG. 2 is a perspective view showing the configuration of a thermoelectric module as shown in FIG. 1;

FIG. 3 illustrates manufacture steps of a substrate on one hand as shown in FIG. 1;

FIG. 4 is a partially enlarged view of a silicon wafer after etching step as shown in FIG. 3;

FIG. 5 illustrates manufacture steps of a substrate on the other hand as shown in FIG. 1;

FIG. 6 illustrates manufacture steps of a thermoelectric element as shown in FIG. 1;

FIG. 7 illustrates assembly steps of the laser module as shown in FIG. 1; and

FIG. 8 is a diagram showing the configuration of a conventional laser module.

### DESCRIPTION OF THE PREFERRED EMBODIMENT

Preferred embodiments of the present invention will now be described with reference to the accompanying drawings.

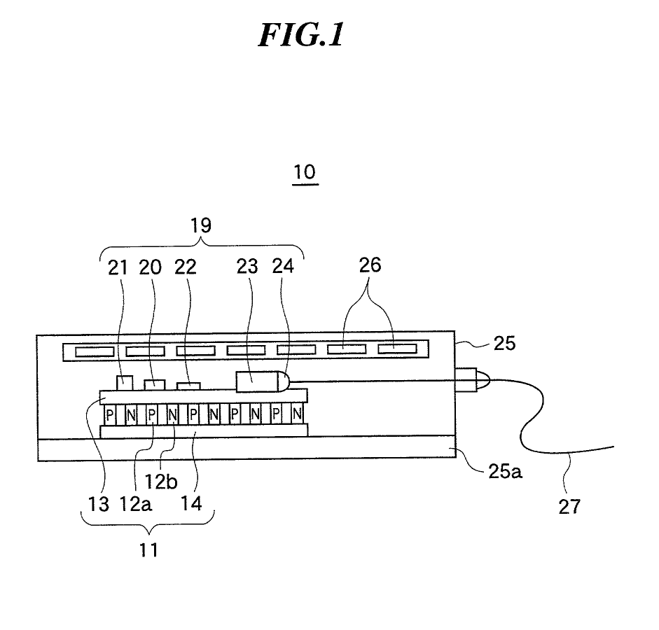

FIG. 1 is a diagram showing a configuration of a laser module according to one embodiment of the present invention.

As seen in FIG. 1, the laser module is generally designated by 10 and comprises a thermoelectric module 11 mounted within the interior of a housing 25. The housing 25 has a bottom 25a which is provided with a Cu—W for heat radiation design. In order to provide a connection with an external circuit, a plurality of lead wires 26 extend in parallel with the top surface of the housing 25. These lead wires are designed to transmit high-frequency signals. The thermoelectric module 11 comprises a plurality of P-type thermoelectric elements 12a, a plurality of N-type thermoelectric elements 12b, and a couple of substrates 13 and 14 which sandwich the P-type and N-type thermoelectric elements therebetween. A most preferred material of the substrate 13 is silicon single crystal.

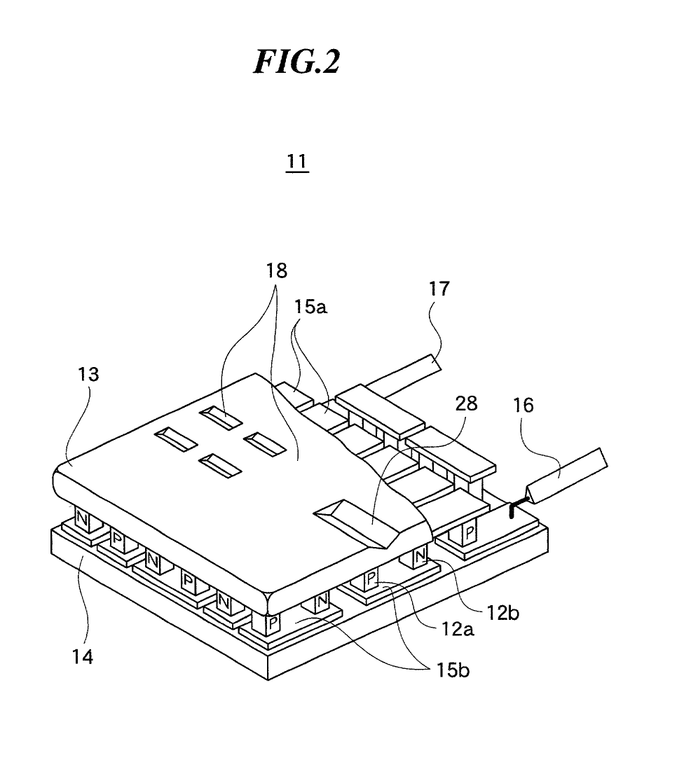

FIG. 2 is a perspective view showing a configuration of the thermoelectric module.

In the thermoelectric module 11, the adjacent P-type thermoelectric element 12a and N-type thermoelectric element 12b are connected with each other by way of electrodes 15b disposed on the top surface of the substrate 14, to form a element pair. A plurality of element pairs are connected in series by way of electrodes 15a disposed on the undersurface of the substrate 13. Terminals 16 and 17 for introduction of current are connected respectively to opposite ends of a series circuit formed by the element pairs.

The top surface of the substrate 13 is formed with a plurality of grooves 18 and 28 which are V-shaped in section. It is preferred that the edge of the substrate 13 be appropriately machined (e.g., chamfered in R). In this case, it is possible to restrain the edge of the substrate 13 from suffering any breakage due to silicon having a lower toughness than that of alumina or the like.

Referring to FIGS. 1 and 2, a semiconductor laser 19 is formed on the top surface of the substrate 13. The semiconductor laser 19 includes a laser chip 20 emitting laser beams, a photodiode 21 for receiving some of the laser beams emitted from the laser chip 20, a thermistor 22 for detecting the temperature, an optical isolator 23 for allowing the laser beams from the laser chip 20 to pass therethrough in a predetermined direction, and a lens 24 for collecting the laser beams which have passed through the optical isolator 23.

In this embodiment, the laser chip 20 and the photodiode 21 are fixedly secured to the grooves 18 of the substrate 13 while the optical isolator 23 and the lens 24 are firmly fastened to the grooves 28 of the substrate 13. The laser chip 20, photodiode 21 and thermistor 22 are electrically connected to respective predetermined lead wires 26. The lead wires 26 in turn are electrically connected to a power supply circuit for supplying the power to the semiconductor laser 19 and electrically connected to a control circuit for controlling the oscillating operations. On the basis of outputs from the photodiode 21 and the thermistor 22, for example, the control circuit changes the power to be supplied to the laser chip 20 by the power supply circuit, to thereby control the oscillating operations of the semiconductor laser 19.

In the semiconductor laser 19, the photodiode 21 receives a laser beam output leftward in FIG. 1 from the laser chip 20 and provides as its output an electric signal which depends on the intensity of the laser beam. The thermistor 22 is utilized for, e.g., the detection of an extraordinary rise in temperature of the substrate 13. A laser beam output rightward in FIG. 1 from the laser chip 20 passes through the optical isolator 23 and the lens 24 in the mentioned order and thereafter transmits through the interior of an optical fiber 27 which extends outward from the housing 25.

This embodiment allows heat generated by the semiconductor laser 19 to be conveyed to the thermoelectric elements 12a and 12b by way of only the substrate 13 made of silicon and the electrode 15a made of an electrically conductive material, to thereby cool the semiconductor laser 19. Silicon has a higher thermal conductivity than alumina (thermal conductivity of alumina: 36.0 W/mK, thermal conductivity of silicon: 148.0 W/mk). It is thus possible to keep a uniform temperature within the surface of the substrate 13 and enhance the heat exchange efficiency between the thermoelectric module 11 and the semiconductor laser 19 as compared with the prior art, to thereby achieve a rapid effective cooling of the semiconductor laser 19.

Since silicon is superior in micro-processibility including etching, markings for positioning the laser chip 20, etc., or fixing grooves for fixing the elements can be formed on the substrate 13 by, e.g., etching, whereby the positioning accuracy upon mounting of the elements on the substrate 13 can be improved.

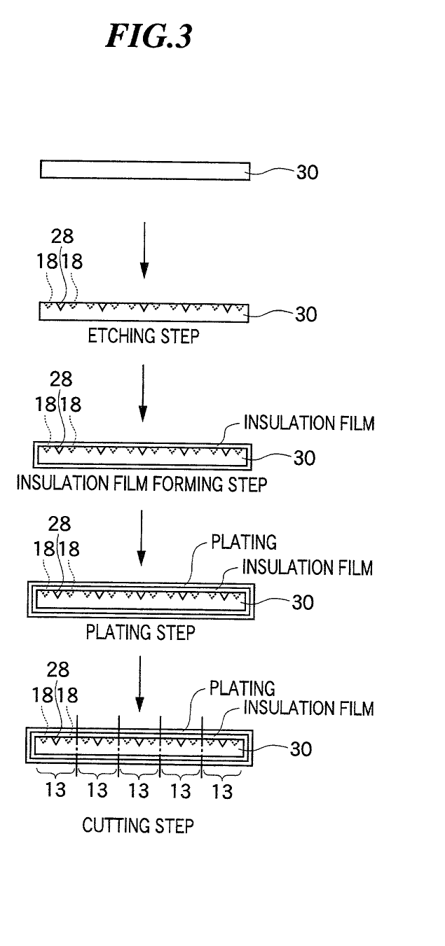

Reference is then made to FIGS. 3 to 7 to describe a method of manufacturing the laser module.

A method of manufacturing the substrate 13 will first be described. FIG. 3 shows manufacture steps of the substrate 13. At first, the surface of a silicon wafer 30 is oxidized and then a resist is formed thereon. A lithography process is then effected so as to form the grooves 18 to which the laser chip 20 and the photodiode 21 (see FIG. 1) are fitted and the grooves 28 to which the optical isolator 23 (see FIG. 1) is fitted.

Next, at the etching step, the exposed oxide film is etched by using the remaining resist as a mask, and then the surface of the exposed silicon wafer 30 is anisotropically etched by using the remaining oxide film as a mask. As a result of the two etchings, the grooves 18 and 28 are formed in the surface of the silicon wafer 30. Afterward, the remaining oxide film and resist are removed from the surface of the silicon wafer 30.

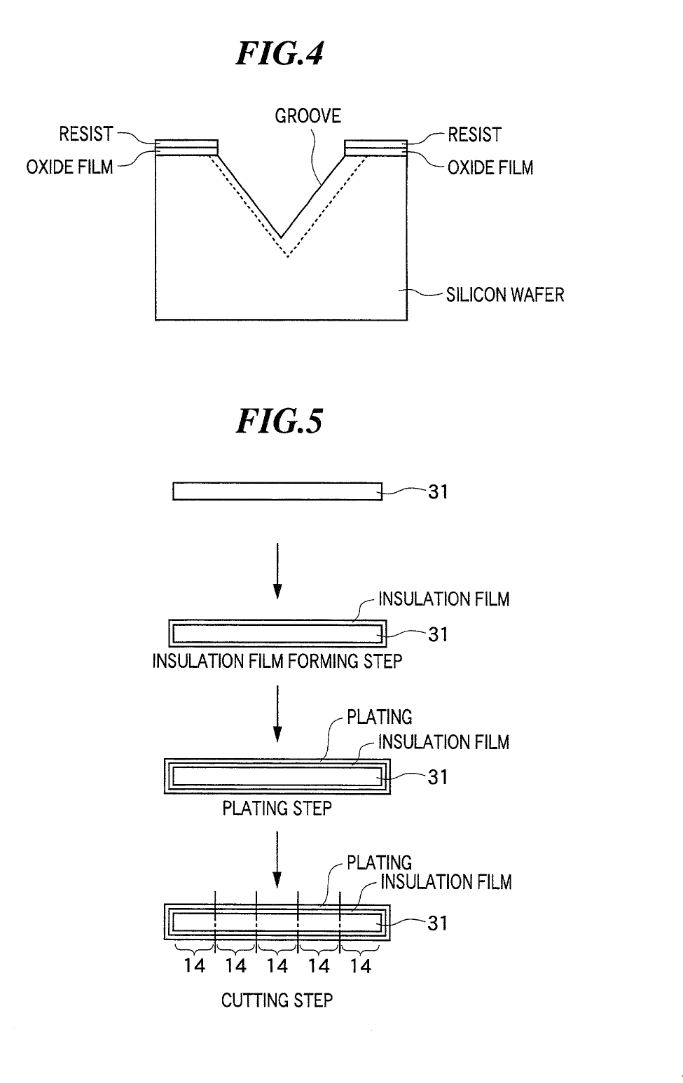

It is preferred that the first etching be a dry etching. The reason is that if the first etching is a wet etching, “under-etching” tends to occur as indicated by a broken line in FIG. 4, as a result of which the second etching proceeds from the exposed surface of the silicon wafer, which may possibly impair the pit accuracy between the grooves. Thus, by effecting the first etching in dry, the silicon wafer can be processed with an extremely high accuracy, thereby facilitating the positioning of the optical elements included in the semiconductor laser.

Referring again to FIG. 3, at the insulation film forming step, an insulation film is formed by means of, e.g., oxide film method or polyimide method over the entire surface of the silicon wafer 30 formed with the grooves 18 and 28. And then, at the plating step, plating is effected thereon by means of, e.g., thin-film adhesion method. Next, at the cutting step, the plated silicon wafer 30 is cut into an appropriate size to obtain the substrate 13.

A method of manufacturing the substrate 14 will hereinafter be described. FIG. 5 shows manufacture steps of the substrate 14. These steps are carried out in parallel with the manufacture steps of the substrate 13.

At the insulation film forming step, an insulation film is formed over the entire surface of a silicon wafer 31 by means of, e.g., oxide film method or polyimide method. And then, at the plating step, plating is effected thereon by means of, e.g., thin-film adhesion method. Next, at the cutting step, the plated silicon wafer 31 is then cut into blocks each having an appropriate size to obtain the substrate 14.

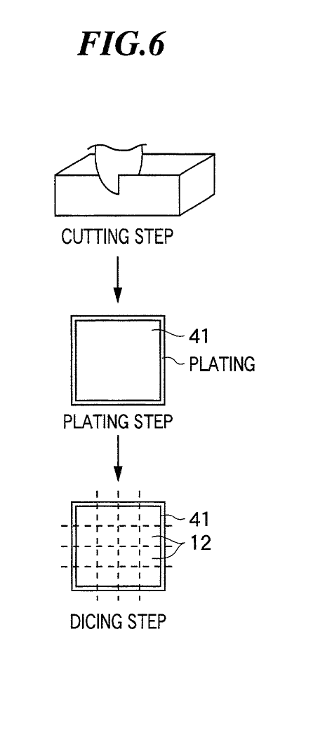

A method of manufacturing the thermoelectric element will then be described. FIG. 6 shows manufacture steps of the thermoelectric element. These steps are carried out in parallel with the manufacture steps of the substrates 13 and 14 for example.

At the cutting step, a bulk material 40 is cut into blocks each having an appropriate size. And then, at the plating step, plating is effected on the entire surface of an element material 41. Next, at the dicing step, the plated element material is then diced into blocks each having an appropriate size to obtain the thermoelectric element 12 (P-type thermoelectric element or N-type thermoelectric element).

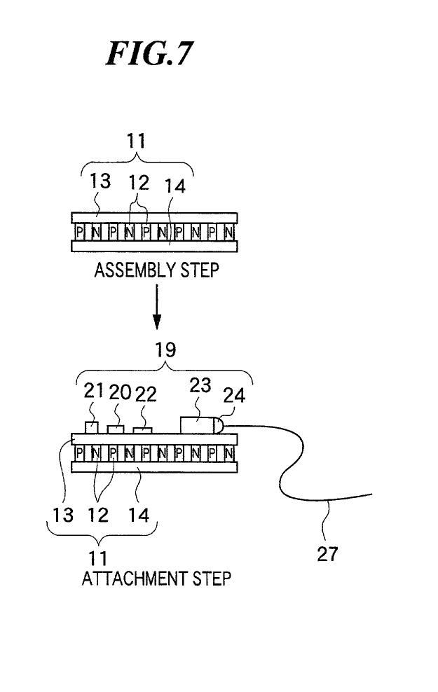

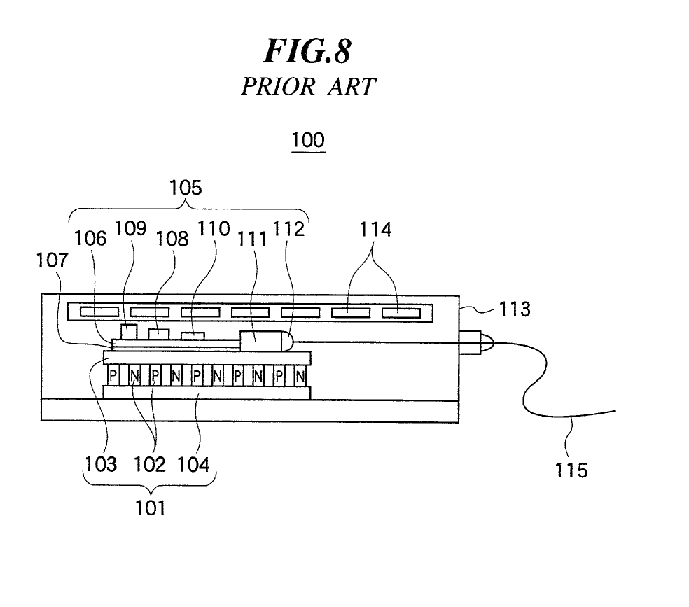

A method of assembling the laser module will then be described. FIG. 7 shows assembly steps of the laser module.

At the assembly step, the thermoelectric module 11 is assembled by sandwiching the plurality of thermoelectric elements 12 formed in accordance with the manufacture steps of FIG. 6 between the substrate 13 formed with the electrodes in accordance with the manufacture steps of FIG. 3 and the substrate 14 formed with the electrodes in accordance with the manufacture steps of FIG. 5. Then, at the attachment step after inspection of the assembled thermoelectric module 11, the laser chip 20 and the photodiode 21 are fixedly secured to the grooves 18 of the substrate 13, while the optical isolator 23 and the lens 24 are firmly fastened to the grooves 28 of the substrate 13. The thermistor 22 is then attached onto the substrate 13. The semiconductor laser 19 is thus formed on the thermoelectric module 11. Then, as shown in FIG. 1, the thermoelectric module 11 provided with the semiconductor laser 19 is mounted within the interior of the housing 25 and the optical fiber 27 is fitted via the lens 24 to the optical isolator 23, to consequently complete the manufacture steps of the laser module 10.

According to the present invention, as set forth hereinabove, at least one of the two substrates included in the thermoelectric module is made of silicon and the semiconductor laser is formed on the silicon substrate, whereby it is possible to enhance the heat exchange efficiency between the thermoelectric module and the semiconductor laser than ever before.

While the illustrative and presently preferred embodiment of the present invention has been described in detail herein, it is to be understood that the inventive concepts may be otherwise variously embodied and employed and that the appended claims are intended to be construed to include such variations except insofar as limited by the prior art.

1. A laser module comprising:
a thermoelectric module including a plurality of thermoelectric elements, and a first substrate and a second substrate for sandwiching the plurality of thermoelectric elements therebetween, at least the first substrate being made of silicon; and
a semiconductor laser formed on the first substrate of the thermoelectric module.

2. A laser module according to claim 1, further comprising:
a housing within which is mounted the thermoelectric module with the semiconductor laser formed thereon.

3. A laser module according to claim 1, wherein:
at least the first substrate of the thermoelectric module has an chamfered edge.

4. A laser module according to claim 1, wherein:
the first substrate of the thermoelectric module has a plurality of regions where grooves for firmly securing components of the semiconductor laser are formed.

5. A laser module according to claim 1, wherein the semiconductor laser includes:
a laser chip for emitting laser beams;
a photodiode for receiving some of the laser beams emitted from the laser chip;
an optical isolator for allowing the laser beams emitted from the laser chip to pass through in a predetermined direction; and
a lens for collecting the laser beams which have passed through the optical isolator.

6. A method of manufacturing a laser module comprising the steps of:
(a) assembling a thermoelectric module by sandwiching a plurality of thermoelectric elements between a first substrate and a second substrate, at least the first substrate being made of silicon; and
(b) forming a semiconductor laser on the first substrate of the thermoelectric module.

7. A method according to claim 6, further comprising, after step (b), the step of mounting within a housing the thermoelectric module with the semiconductor laser formed thereon.

8. A method according to claim 6, further comprising, prior to step (a), the step of chamfering an edge of at least the first substrate.

9. A method according to claim 6, further comprising, prior to step (a), the step of forming grooves for firmly fastening components of the semiconductor laser in a plurality of regions of the first substrate.

10. A laser module manufacturing method according to claim 6, wherein:
step (b) includes fixedly securing to the first substrate of the thermoelectric module a laser chip for emitting laser beams, a photodiode for receiving some of the laser beams emitted from the laser chip, an optical isolator for allowing the laser beams emitted from the laser chip to pass through in a predetermined direction, and a lens for collecting the laser beams which have passed the optical isolator.
